(19) United States
(12) Patent Application Publication
(10) Pub. No.: US 2012/0166135 A1
(43) Pub. Date: Jun. 28, 2012

(54) Method for Determining a Physical Parameter, Imaging Method, and Device for Implementing Said Method

(75) Inventors: Ros Kiri Ing, Ivry sur Seine (FR); Nicolas Etaix, Gentilly (FR); Alexandre LeBlanc, Saint-Nicolas (FR); Mathias Fink, Meudon (FR)

(73) Assignees: Mathias Fink, Maeudon (FR); Ros Kiri Ing, Paris (FR)

(21) Appl. No.: 13/388,883

(22) PCT Filed: Jul. 29, 2010
(86) PCT No.: PCT/FR10/51618

§ 371 Date: Mar. 13, 2012

(30) Foreign Application Priority Data
Aug. 11, 2009 (FR) 0955629

(51) Int. Cl. G01B 17/06; G01B 17/02; G01H 5/00

(52) U.S. Cl. 702/142; 702/171; 702/167

(57) ABSTRACT

The invention relates to a method for determining a physical parameter representative of a point P of a plate by means of a device comprising a first receiver for measuring a wave propagating in the plate, and a calculation unit. The method includes the following steps: measuring, by means of the first receiver, a first signal s₁(t) representative of a wave propagating in the plate; defining a closed contour C on the plate surrounding said point P, the contour C being the location on the plate on which either a wave is generated by a first emitter, or the first signal s₁(t) is measured; and determining the physical parameter at point P on the plate by identifying, thanks to at least said first signal, a shape function fₛₕₐₚₑ(f), in the following equation: formula (I), where W_{contour} and Gₚₗₐₜₑ are functions of Green, and the shape function fₛₕₐₚₑ(f) is dependent on the frequency f of the wave and on the physical parameter.

The invention relates to a method for determining a physical parameter representative of a point P of a plate, a device for implementing said method, and a transducer for emitting and/or receiving a wave on said plate.

More particularly, the invention relates to a method for determining a physical parameter representative of a point P of a plate, wherein the physical parameter is chosen from among the thickness of the plate h, the propagation speed of a wave in the plate V_{P}, and the product V_{P}h of the thickness and the propagation speed of a wave in the plate, and said method is implemented by a device comprising:
at least a first receiver adapted to measure a wave propagating in the plate, and
a calculation unit connected to said first receiver.

Methods of this type are known. In particular, in one known method, a vibration wave is generated or emitted at a first point of the plate, the received wave is measured at a second point of the plate, and the time-of-flight of the wave between the first and second points is estimated. The distance separating the first and second points then allows estimating the propagation speed of the wave in the plate.

The accuracy of the time measurement is important to the accuracy of this estimate, and this method requires a high frequency wave sensitive to the condition of the plate surface.

In addition, this method requires a model of the plate in order to determine the plate thickness. The model incorporates the connections and boundary conditions, which increases the complexity of the method and, above all, adds uncertainty related to the values of the parameters for the model used.

The aim of the invention is to offer an alternative to the known methods, and in particular to allow accurately estimating physical parameters of a plate.

For this purpose, the method of the invention is characterized by said method comprising the following steps:
said first receiver is used to measure a first signal s₁(t) representative of a wave propagating in the plate,
a closed contour C surrounding said point P is defined on the plate, the contour C being the plate location at which either a first emitter is used to generate a wave propagating in the plate, or said first receiver is used to measure said first signal s₁(t) representative of a wave propagating in the plate, and
the physical parameter is determined at point P of the plate by using at least said first signal s₁(t) to identify a shape function ƒₛₕₐₚₑ(f) in the following relation:

W_{contour}(\vec{r})=fₛₕₐₚₑ(f)Gₚₗₐₜₑ(\vec{r}−\vec{r}ₛ)

where
W_{contour} is a Green's function representing the wave along the contour C,
Gₚₗₐₜₑ is a Green's function representing the wave at a point of position vector \vec{r} of the plate that is not a part of the contour C, relative to a point S of position vector \vec{r}ₛ of the plate representing a source of the wave, and
   said shape function ƒₛₕₐₚₑ(f) is dependent on at least the frequency f of the wave and the physical parameter, and is adapted to the shape of the contour C.

With these arrangements, it is possible to determine a physical parameter of the plate at point P, in a simple and precise manner.

In various embodiments of the method of the invention, one or more of the following may be used:
the shape function is a Bessel function of the first kind J₀(Z) comprising zeros Zₙ, being a positive integer or 0, said Bessel function being a function of a scale parameter a multiplied by the square root of the frequency f of the wave, such that:

J₀(Z)=J₀(a\sqrt{f});
the first receiver is adapted to measure a wave on the contour C, and said method comprises the following step:
   if the first signal s₁(t) has an amplitude less than a predetermined threshold for a set of test frequencies fₙ, the test frequencies fₙ being proportional to the square of the zeros Zₙ, of the Bessel function of the first kind J₀, then the scale parameter a is calculated by:

$$a = \frac{{Z}_{n}}{\sqrt{{f}_{n}}} ;$$

the device additionally comprises a first emitter, one of the first emitter and first receiver being adapted either to generate or to measure a wave on the contour C, the other being adapted either to generate or to measure a wave at a point of the plate that is not a part of the contour C, and said method comprises the following steps:
   a first wave is generated in the plate by a first emission signal e₁(t) for the first emitter,
   the first receiver is used to measure a first signal s₁(t) representative of said first emitted wave, and
   if the first signal s₁(t) has an amplitude less than a predetermined threshold for a set of test frequencies fₙ, the test frequencies being proportional to the square of the zeros Zₙ of the Bessel function of the first kind J₀, then the scale parameter a is calculated by:

$$a = \frac{{Z}_{n}}{\sqrt{{f}_{n}}} ;$$

the device additionally comprises a second receiver, the first receiver being adapted to measure a wave on the contour C and the second receiver being adapted to measure a wave at a point of the plate that is not a part of the contour C, and said method comprises the following steps:
   the first receiver is used to measure a first signal s₁(t) representative of a first wave, and simultaneously the second receiver is used to measure a second signal s₂(t) representative of said same first wave;
the device additionally comprises:
   a second receiver, and
   a first emitter,
      one of the first receiver, second receiver, and first emitter being adapted to measure or to generate a wave on the contour C, and said method comprises the following steps:
a first wave is generated in the plate by a first emission signal e₁(t) for the first emitter,
the first receiver is used to measure a first signal s₁(t) representative of said first emitted wave, and simultaneously the second receiver is used to measure a second signal s₂(t) representative of said same first emitted wave.
the device additionally comprises:
   a first emitter, and
   a second emitter,
      one of the first receiver, first emitter, and second emitter being adapted to measure or to generate a wave on the contour C, and said method comprises the following steps:
a first wave is generated in the plate by a first emission signal ea for the first emitter,
the first receiver is used to measure a first signal s₁(t) representative of said first emitted wave,
a second wave is generated in the plate by a second emission signal e₂(t) for the second emitter,
the first receiver is used to measure a second signal s₂(t) representative of said second emitted wave;
the second emission signal e₂(t) is phase shifted by π/2 relative to the first emission signal e₁(t), and said method comprises the following steps:
   a summed signal s(t) is calculated which is the sum of the first signal s₁(t) and a second signal s₂(t), and
   if the first signal s₁(t) is in phase with the summed signal s(t), for a set of test frequencies fₙ, the test frequencies fₙ being proportional to the square of the zeros Zₙ of the Bessel function of the first kind J₀, then the scale parameter a is calculated by:

$$a = \frac{{Z}_{n}}{\sqrt{{f}_{n}}} ;$$

the device additionally comprises:
   a first emitter, and
   a second emitter,
      one of the first receiver, first emitter, and second emitter being adapted to measure or to generate a wave on the contour C, and said method comprises the following steps:
a first wave is generated in the plate by a first emission signal e₁(t) for the first emitter, and simultaneously a second wave is generated by a second emission signal e₂(t) for the second emitter, and
the first receiver is used to measure a first signal s₁(t) representative of the superpositioning of said first and second emitted waves at the location of the first receiver;
in the method:
   the second emission signal e₂(t) is phase shifted by π/2 relative to the first emission signal e₁(t), and said method comprises the following steps:
   if the first signal s₁(t) is in phase with the first emission signal e₁(t), for a set of test frequencies fₙ, the test frequencies fₙ, being proportional to the square of the zeros Zₙ of the Bessel function of the first kind J₀, then the scale parameter a is calculated

$$a = \frac{{Z}_{n}}{\sqrt{{f}_{n}}} ;$$

the method comprises the following steps:
   a summed signal s(t) is calculated, which is the sum of the first signal s₁(t) and a phase-shifted second signal s₂*(t), the phase-shifted second signal s₂*(t) being equal to the second signal s₂(t) phase-shifted by π/2, and
   if the first signal s₁(t) is in phase with the summed signal s(t), for a set of test frequencies fₙ, the test frequencies fₙ being proportional to the square of the zeros Zₙ, of the Bessel function of the first kind J₀, then the scale parameter a is calculated by:

$$a = \frac{{Z}_{n}}{\sqrt{{f}_{n}}} ;$$

the method comprises the following steps:
   a first Fourier transform S₁(f) of the first signal s₁(t) and a second Fourier transform S₂(f) of the second signal s₂(t) are calculated,
   a test function ƒₜₑₛₜ(f) is calculated which compares the sign of the real part of the first Fourier transform S₁(f) to the sign of the real part of the second Fourier transform S₂(f), and which assigns a first value V₁ if the signs are identical and a second value V₂ if the signs are different:

$$\{ \begin{matrix}if sign ( ℛ ( {S}_{1} ( f ) ) ) = sign ( ℛ ( {S}_{2} ( f ) ) ) & then {f}_{test} ( f ) = {V}_{1} \\ else & {f}_{test} ( f ) = {V}_{2}\end{matrix}$$

specific frequencies fₙ at which the test function ƒₜₑₛₜ(f) changes value are looked for, either changing from the first value V₁ to the second value V₂, or conversely from the second value V₂ to the first value V₁, and
the scale parameter a is calculated by:

$$a = \frac{{Z}_{n}}{\sqrt{{f}_{n}}} ;$$

the method comprises the following steps:
   a first Fourier transform S₁(f) of the first signal s₁(t) and a second Fourier transform S₂(f) of the second signal s₂(t) are calculated,
   a phase difference Δφ between the first Fourier transform and the second Fourier transform is calculated, using:

Δφ=φ(S₂(f)−S₁(f))
specific frequencies fₙ, of the phase difference Δφ are looked for, at which said phase difference has a jump between 0 and π or between π and 0, and which are proportional to the square of the zeros Zₙ of the Bessel function of the first kind J₀, and
the scale parameter a is calculated by:

$$a = \frac{{Z}_{n}}{\sqrt{{f}_{n}}} ;$$

the method comprises the following steps:
   a first Fourier transform S₁(f) of the first signal s₁(t) and a second Fourier transform S₂(f) of the second signal s₂(t) are calculated,
   the scale parameter a is determined such that the modulus of the following shape function:

|bJ₀(a\sqrt{f})|,

where b is another scale parameter, and

|.| is the modulus function,

best approaches:

|S₂(f)/S₁(f)|

for a set of test frequencies fₙ;
the method comprises the following steps:
   a first Fourier transform S₁(f) of the first signal s₁(t) and a second Fourier transform S₂(f) of the second signal s₂(t) are calculated,
   the scale parameter a is determined such that the phase of the following shape function:

φ(bJ₀(a\sqrt{f})),

where b is another scale parameter, and

φ(.) is the phase function,

best approaches:

φ(S₂(f)/S₁(f))

for a set of test frequencies fₙ;
the physical parameter that is the product V_{P}h, said product being the thickness multiplied by the propagation speed of a wave in the plate, is determined by the following formula:

$${V}_{P} h = 4 \sqrt{3} π \frac{1}{{a}^{2}} {R}^{2}$$

where
a is the scale parameter of the Bessel function, previously determined, and
R is the length of a segment between the point P and a point of the contour C in the direction of the wave;
   the physical parameter that is the thickness h of the plate is determined by the following formula:

$$h = 4 \sqrt{3} π \frac{1}{{a}^{2}} \frac{{R}^{2}}{{V}_{P}}$$

where
a is the scale parameter of the Bessel function, previously determined,
R is the length of a segment between the point P and a point of the contour C in the direction of the wave, and
V_{P} is the known propagation speed of a wave in the material of the plate;
   the physical parameter that is the propagation speed V_{P} of a wave in the plate is determined by the following formula:

$${V}_{P} = 4 \sqrt{3} π \frac{1}{{a}^{2}} \frac{{R}^{2}}{h}$$

where
a is the scale parameter of the Bessel function, previously determined,
R is the length of a segment between the point P and a point of the contour C in the direction of the wave, and
h is the known thickness of the plate;
   the contour C is substantially a circle of radius R centered on the point P;
   the contour C is substantially an ellipse centered on the point P;
   the shape of the contour C is determined beforehand using:

a test device comprising:
a first emitter adapted to generate a wave at point P,
at least a second emitter adapted to generate a wave on a test contour Cₙ having the predetermined shape of an ellipse, n being a positive integer index,
first and second receivers adapted to measure a wave at points that are not a part of the test contour Cₙ, and using:

a test method comprising the following test steps:
a first wave is generated in the plate by a first emission signal e₁(t) for the first emitter,
the first receiver is used to measure a first signal s₁₁(t) representative of said first emitted wave and a first Fourier transform S₁₁(f) of this first signal is calculated,
the second receiver is used to measure a second signal s₁₂(t) representative of said first emitted wave, and a second Fourier transform S₁₂(f) of this second signal is calculated,
a second wave is generated in the plate by a second emission signal e₂(t) for the second emitter,
the first receiver is used to measure a third signal s₂₁(t) representative of said second emitted wave, and a third Fourier transform S₂₁(f) of this third signal is calculated,
the second receiver is used to measure a fourth signal s₂₂(t) representative of said second emitted wave, and a fourth Fourier transform S₂₂(f) of this fourth signal is calculated,
the following phase difference function is calculated:

Δφ(f)=φ(S₁₁(f)S₁₂(f)*)−φ(S₂₁(f)S₂₂(f)*)

where
* indicates the conjugate function, and
φ(.) is the phase function, and
the ellipse shape of the test contour Cₙ corresponds to an optimum contour, such that the first wave is propagated and spatially superimposed on the plate substantially on the second wave, when the phase difference function Δφ(f) is minimal for a set of test contours Cₙ to which the above test steps are applied;
the contour C is substantially a rectangle centered on the point P;
the contour C comprises eight contour points C1 to C8, and wherein said contour points and the point P form a regular rectangular grid;
the segment of length R is a segment of mean length calculated by:

$$R = \frac{{d}_{1} + {d}_{2}}{2}$$

where
d₁ is half the length of the longest median of said rectangle, and
d₂ is the length of the diagonal of said rectangle.

The invention also relates to an imaging method, wherein an image of a plate is constructed, said image comprising a plurality of pixels, each pixel corresponding to a point of the plate and representing a physical parameter of the plate at said point of the plate, said physical parameter of said point being determined by the method defined above.

The invention also relates to a device for implementing the method for determining a physical parameter representative of a point P of a plate according to any of the above, wherein the physical parameter is chosen from among the thickness of the plate h, the propagation speed of a wave in the plate V_{P}, and the product V_{P}h of the thickness and the propagation speed of a wave in the plate, said device comprising:
at least a first receiver adapted to measure a first signal s₁(t) representative of a wave propagating in the plate,
a closed contour C defined by surrounding said point P, the contour C being the plate location at which either a first emitter is used to generate a wave propagating in the plate, or said first receiver is used to measure said first signal s₁(t) representative of a wave propagating in the plate, and
a calculation unit connected to said first receiver,
   said calculation unit being adapted to determine the physical parameter at point P of the plate by using at least said first signal s₁(t) to identify a shape function ƒₛₕₐₚₑ(f) in the following relation:

W_{contour}(\vec{r})=fₛₕₐₚₑ(f)Gₚₗₐₜₑ(\vec{r}−\vec{r}_{S})

where
W_{contour} is a Green's function representing the wave along the contour C,
Gₚₗₐₜₑ is a Green's function representing the wave at a point of position vector \vec{r} of the plate that is not a part of the contour C, relative to a point S of position vector \vec{r}ₛ of the plate representing a source of the wave, and
   said shape function ƒₛₕₐₚₑ(f) is dependent on at least the frequency f of the wave and the physical parameter, and is adapted to the shape of the contour C.

In various embodiments of the device of the invention, one or more of the following may be applied:
the first receiver is a scanning laser vibrometer;
the device additionally comprises a second receiver, and the second receiver is realized by said scanning laser vibrometer.

Other features and advantages of the invention will be apparent from the following description of some of its embodiments, provided as non-limiting examples, with reference to the attached drawings.

In the drawings:

FIG. 1 is a view of a plate to which the invention can be applied;

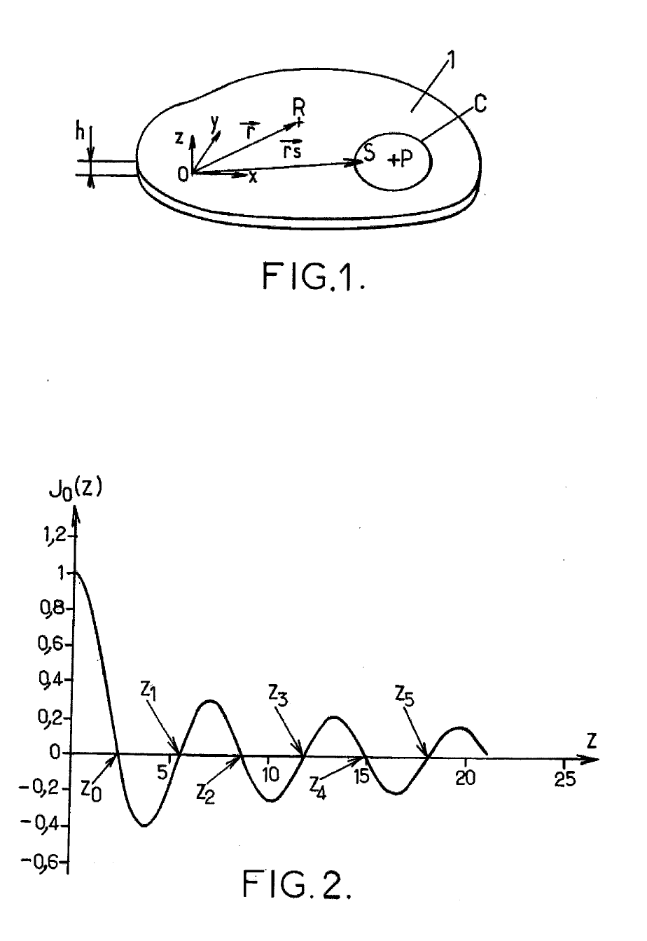

FIG. 2 represents a Bessel function of the first kind J₀(Z);

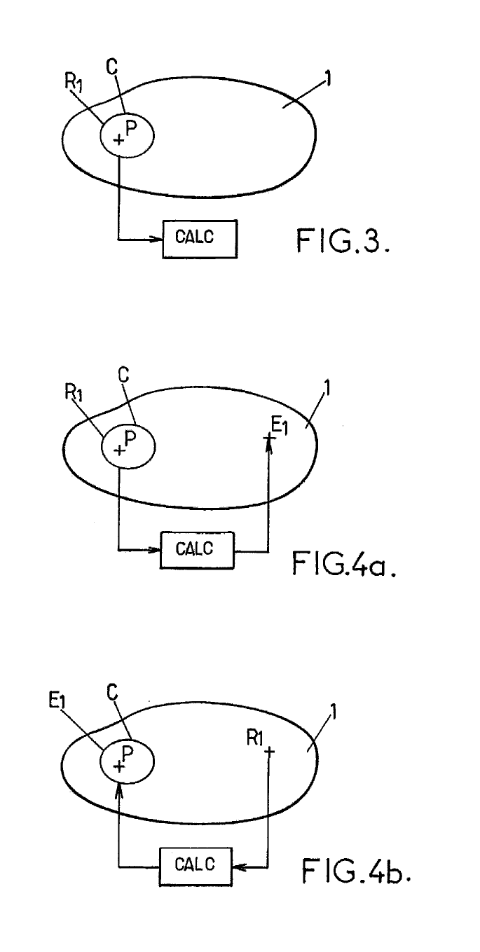

FIG. 3 is a first embodiment of a device of the invention;

FIGS. 4a and 4b are a second embodiment of a device of the invention;

FIG. 5 is a third embodiment of a device of the invention;

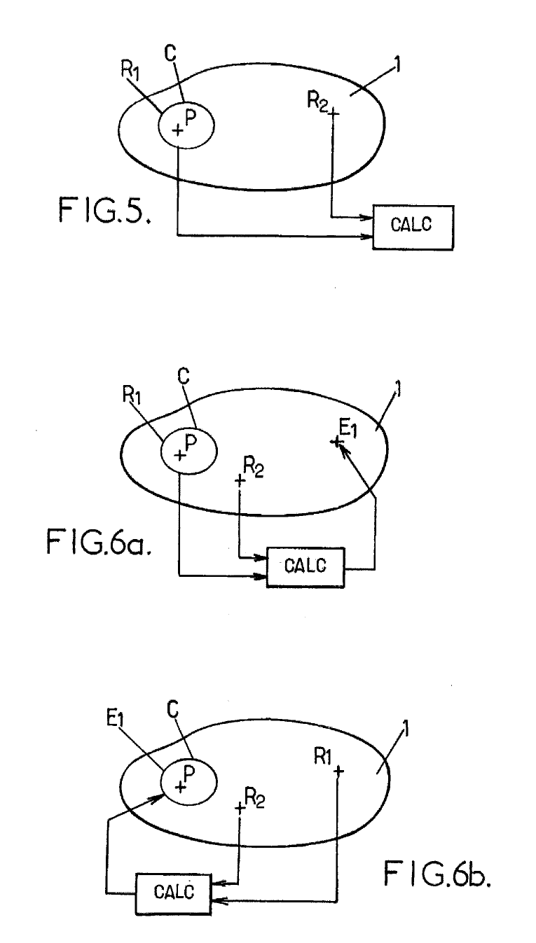

FIGS. 6a and 6b are a fourth embodiment of a device of the invention;

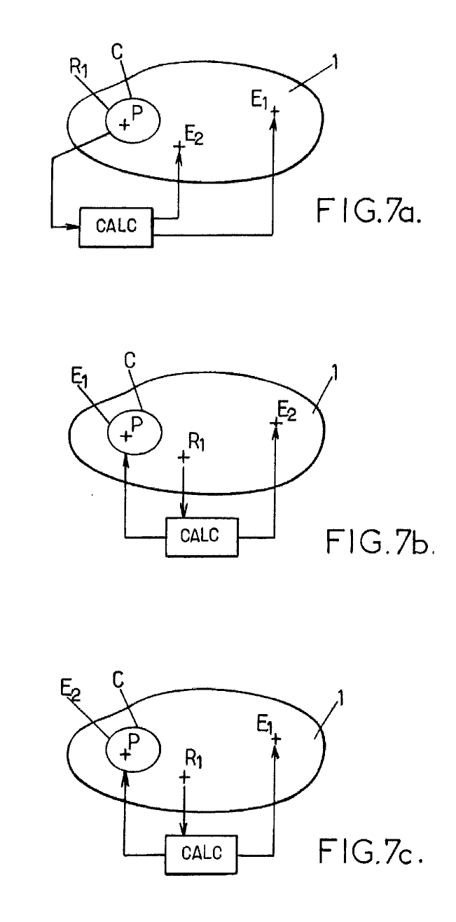

FIGS. 7a, 7b and 7c are a fifth embodiment of a device of the invention;

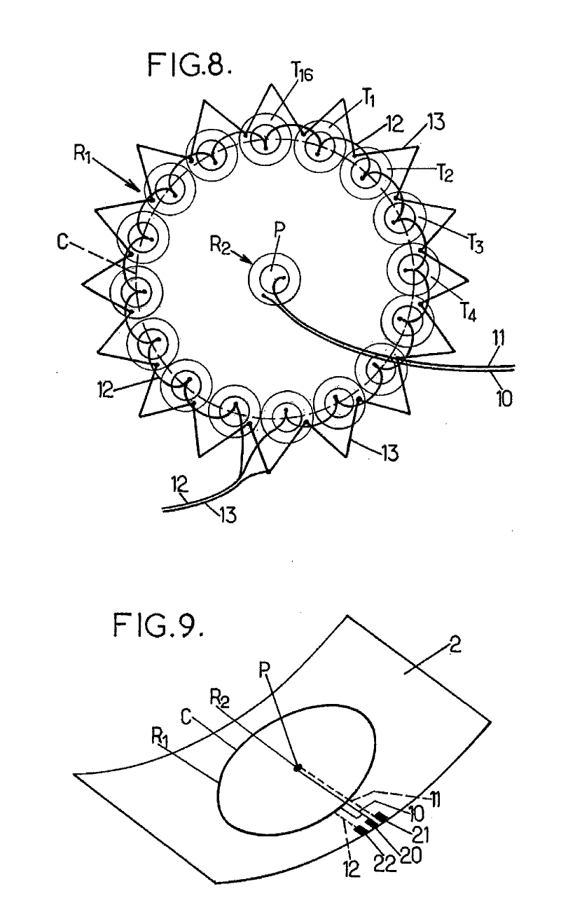

FIG. 8 represents a first transducer adapted to implement the invention;

FIG. 9 represents a second transducer adapted to implement the invention;

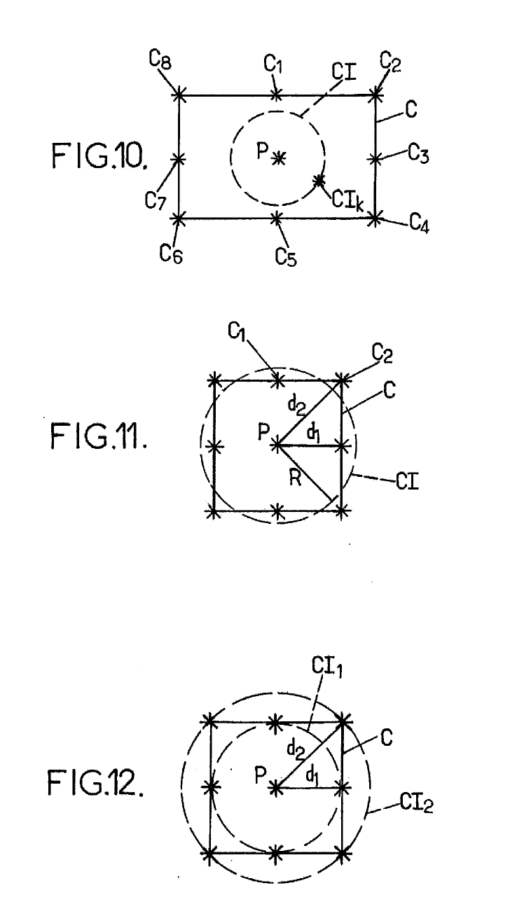

FIGS. 10 to 12 illustrate variants of the method of the invention;

FIG. 13 represents an image obtained using the method of the invention.

In the rest of this document, the term “vibration” will be understood as indicating a vibration wave, an acoustic wave, or an ultrasound wave. The wave in question has a frequency, for example, of between 100 Hz and 50 kHz, and preferably between 1000 Hz and 20 kHz, such that inexpensive materials can be used to measure such a wave.

The invention relates to a method for determining a physical parameter representative of a point P of a plate 1, wherein the physical parameter is chosen in particular from among the thickness of the plate h, the propagation speed of a wave in the plate V_{P}, and the product V_{P}h of the thickness and the propagation speed of a wave in the plate.

The method is implemented by a device comprising:
at least one receiver R1 adapted to perform at least one measurement of a wave on said plate, and
a calculation unit CALC connected to said receiver, adapted to obtain said measurement from said receiver, and adapted to determine said physical parameter at point P based on said measurement.

A point P is defined on the plate, corresponding to the location where said physical parameter is to be determined, and a closed contour C surrounding said point P is also defined.

The method is based on the emitting, by an emitter, of a wave on the contour C or, reciprocally, the receiving, by a receiver, of a wave on the contour C. The principle of reciprocity for the propagation of an acoustic or vibration wave in a structure leads to various ways of embodying this method, in which the elements are either emitters or receivers.

The wave can be a vibration, acoustic, or ultrasound wave. It propagates in the plate or on a surface of the plate. This wave can be measured by a receiver, or generated by an emitter.

An emitter or receiver of a wave can be a transducer, for example a device of piezoelectric material attached to the plate. In a receiver mode, the transducer converts a displacement, deformation, stress, or pressure into a voltage, representing a measurement of said displacement, deformation, stress or pressure. The voltage can be converted by an analog-to-digital converter to provide a digital value to a calculation unit. Reciprocally, in an emitter mode, the transducer converts a voltage into a displacement, deformation, stress, or pressure. The voltage can be produced by a digital-to-analog converter of a calculation unit, possibly followed by a voltage amplifier.

Alternatively, the emitter or receiver may have no contact with the plate. For example, an electromagnetic transducer or high power laser operating in pulse mode can be used. Reciprocally, an optical receiver can be used such as a laser vibrometer, adapted for measuring, remotely and without direct contact, a vibration of a point or a multitude of points on a plate.

An emitter or receiver on a contour C may also be realized in multiple ways.

A first possibility is to make use of piezoelectric transducers. A predetermined number T of transducers Tᵢ are attached or placed on the plate, where is a positive integer index between 1 and T. These transducers are placed, possibly regularly, along the contour C, as represented in FIG. 8. For example, T can be equal to 3, 4, 8 or 16. It is understood that the longer the contour C, the higher the number T of transducers must be to obtain a signal or generate a wave equivalent to a transducer that is continuous along the contour C. Each piezoelectric transducer comprises an anode and a cathode. All the transducers are then connected in parallel, meaning that all the anodes are connected to each other by a first conductor 12, and all the cathodes are connected to each other by a second conductor 13. The set of transducers Tᵢ therefore forms a single transducer, supplied power by only two conductors 12, 13. It can then be connected to a device in the same manner as a single transducer, such as the transducer P powered by two other conductors 10, 11. As a variant (not represented), instead of being interconnected in parallel, the transducers could be assembled serially, which would yield an equivalent result.

In a second possibility, represented in FIG. 9, a transducer for measuring a wave along a contour C can be realized using a piezoelectric polymer material, such as polyvinylidene fluoride (PVDF). This material is flexible and can be shaped into the desired form on an adhesive film 2 designed to adhere to the plate 1 via its bottom side. The film 2 comprises a disc P of PVDF surrounded by a circular contour C of PVDF. The disc P is connected to a first terminal 20 by a conductor 10, and to a second terminal 21 by a conductor 11. The contour C is connected to said first terminal 20 and to a third terminal 22 by a third conductor 12. The connecting terminals are, for example, located at the edge of the film 2, and each has a conductive top side on the top side of the film 2, adapted for connection to a device.

Such a device therefore integrates a first and second receiver R1, R2 in a manner that may be used to implement the method of the invention. In addition, this device may be low in cost and easy to implement.

In a third possibility, a vibrometer (not represented) is used. The vibrometer advances along the contour C by predetermined increments to produce the measurement of each point on said contour C. The measurement on the contour C will then be calculated digitally by summing the signals from each point.

The same vibrometer can be used to obtain measurements of one or more other points on the plate which are not part of the contour C, such that a single measurement device is used to perform all necessary measurements.

When it is stated in this patent application that a wave is emitted or received on a contour C, it is understood that a predetermined number of interconnected transducers can be positioned on the plate, for measuring or generating this wave for the entire contour C, or that a no-contact sensor such as a scanning vibrometer can be used to perform this function, or any other known means can be used.

In a fourth possibility (not represented), piezoelectric transducers are used of the type presented in the first possibility in FIG. 8, for example of ceramic, assembled on a flexible film, for example of plastic, so that the transducers Tᵢ are placed at predetermined positions relative to each other and forming a closed contour C around a transducer P inside said contour C. The number T of transducers can be 3, 4, 8 or 16, or more if the contour is of significant length.

The film may have one side coated with an adhesive for directly attaching all the transducers to the plate. The adhesive will, however, not be present on the entire film but only under the transducers, and the film must have a low elasticity so that the assembly does not locally modify the vibration response of the plate.

As a variant, the transducers may have a side coated with an adhesive for directly attaching them to the plate.

The transducers Tᵢ are connected to each other with flexible electrical conductors formed on the film, and according to the same principle as for the first possibility. The transducers Tᵢ, the transducer P, the film, and the flexible conductors together form a product comprising a first and second receiver R1, R2 for implementing the method. In addition, this assembly is ready for fast and easy placement on a plate.

The theoretical foundation that provides an understanding of the various embodiments of the device and method of the invention is described below. FIG. 1, representing a plate 1, provides an illustration of this description.

Using a thin-plate mechanics approach in the frequency domain, the radiation from a point in the plate is governed by the following equation:

D∇⁴w(\vec{r})+ρhω²w(\vec{r})=δ(\vec{r}) (1)

where
\vec{r} is the position vector for the point in the plate, preferably in polar coordinates,
ω is the wave pulse where ω=2πf, f being the wave frequency,
ρ is the mass density of the material of the plate,
and
h is the thickness of the plate,
δ is the Dirac delta function representing a localized source centered at the origin of the coordinates;
   and

$$D = \frac{{Eh}^{3}}{12 ( 1 - {σ}^{2} )} , \qquad ( 2 )$$

where
E is the Young's modulus for the material of the plate, and
σ is the Poisson's ratio for the material.

For an infinite plate, the solution of this equation is a Green's function G_{free} for a point of coordinates F and with a vibration or acoustic source placed at point S of the plate and coordinates \vec{r}ₛ:

$$\begin{matrix}{G}_{free} ( \vert \vec{r} - {\vec{r}}_{s} \vert ) = \frac{i}{8 {k}^{2} D} [ {H}_{0}^{( 1 )} ( k \vert \vec{r} - {\vec{r}}_{s} \vert ) - {H}_{0}^{( 1 )} ( ik \vert \vec{r} - {\vec{r}}_{s} \vert ) ] \\ where & ( 3 ) \\ {k}^{4} = \frac{ρ h {ω}^{2}}{D} , & ( 4 )\end{matrix}$$

H₀ is the Hankel function of the first kind.

For a plate of finite dimensions, the vibration wave also results from the interference with multiple waves reflected at the edges of the plate, such that the Green's function Gₚₗₐₜₑ for the point of coordinates F on a plate of finite dimensions, can be written as:

Gₚₗₐₜₑ(|\vec{r}−\vec{r}ₛ|)=G_{free}(|\vec{r}−\vec{r}ₛ)+C_{refl}(G_{free}(|\vec{r}−\vec{r}ₛ|)) (5)

where
C_{refl} is a function which represents only the reflections at the edges of the plate. This function depends on the Green's function G_{free} on a plate of infinite dimensions. This function is linear.

The radiation from the contour C can then be calculated by summing the localized radiations along this contour, each one calculated using the above formula. In the case of a contour C that is a circle, applying the addition theorem for cylindrical harmonics yields the Green's function W_{circle} for a contour C having a circular shape on a plate of finite dimensions:

W_{circle}(\vec{r})=2πAJ₀(kR)Gₚₗₐₜₑ(|\vec{r}−\vec{r}ₛ), (6)

where
A is an amplitude, and
J₀ is a Bessel function of the first kind dependent on the product of a wavenumber k and the radius of the circle R.

In addition:

$${k}^{2} = \frac{4 \sqrt{3} π f}{{V}_{P} h} , \qquad ( 7 )$$

where:
V_{P} is the parameter of wave propagation speed in the plate,
f is the wave frequency, and
h is the plate thickness.

The following product kR is therefore obtained:

$$kR = 2 \sqrt{\sqrt{3} π} \sqrt{\frac{f}{{V}_{P} h}} R \approx 4.665361 \sqrt{\frac{f}{{V}_{P} h}} R \qquad ( 8 )$$

Thus the product V_{P}h, multiplying the thickness of the plate h by the propagation speed of the wave in the plate V_{P}, is written:

$${V}_{P} h = \frac{4 \sqrt{3} π {R}^{2`}}{{( kR )}^{2}} f \qquad ( 9 )$$

The Bessel function J₀(Z) is an oscillating function, represented in FIG. 2. This function cancels out or presents zeros or roots for specific abscissa values Zₙ, n being a zero or positive integer index. The first five zeros can be denoted Z₀, Z₁, Z₂, Z₃, Z₄, Z₅ and they have the approximate values:

Z₀≈2.4048

Z₁≈5.5201

Z₂≈8.6537

Z₃≈111.7915

Z₄≈14.9309

Z₅≈18.0711 (10)

The zeros of the Bessel function J₀ are spaced apart in a periodic manner, such that, when the frequency of a wave is known, one can determine the products kR corresponding to each zero Zₙ, and from this can determine the product V_{P}h which multiplies the thickness h by the propagation speed of the wave in the plate V_{P}. Thus a physical parameter of the plate is determined.

Various embodiments of the device are possible, each having multiple variants.

In a first embodiment of the device represented in FIG. 3, the device comprises a single receiver R1. This receiver or vibration sensor R1 is adapted to measure a wave on the contour C of the plate. The contour C is possibly a circle of radius R centered on a point P. This first embodiment does not comprise an emitter. It is therefore a passive device, which uses the noise and/or vibrations of the environment of the device.

In a second embodiment of the device, the device comprises a single receiver R1 and a single emitter E1. If the receiver or sensor R1 is adapted to measure a wave on the contour C of the plate, the emitter E1 is adapted to generate a wave at any point of the plate that is not part of the contour C (FIG. 4a). Reciprocally, if the emitter E1 is adapted to generate a wave on the contour C of the plate, the receiver R1 is adapted to measure a wave at any point of the plate that is not part of the contour C (FIG. 4b). The contour C is possibly a circle of radius R centered on a point P. This second embodiment comprises an emitter, and is therefore an active device.

In a third embodiment of the device, the device comprises two receivers R1, R2, but no emitter. FIG. 5 shows an example of a device according to this third embodiment. A first receiver R1 is adapted to measure a wave on the contour C of the plate. The contour C is possibly a circle of radius R centered on a point P. A second receiver R2 is adapted to measure a wave at any point of the plate that is not part of the contour C. In particular, this second receiver R2 can be adapted to measure a wave at the point P or at a point inside the contour C, meaning surrounded by the contour C, or at a point outside the contour C. This third embodiment does not comprise an emitter, and is therefore a passive device.

In a fourth embodiment of the device, the device comprises two receivers R1, R2 and one emitter E1. FIGS. 6a and 6b show an example of a device according to this fourth embodiment. The emitter E1, the receivers R1, R2 can be adapted to measure or to generate a wave, on the contour C or at any first point of the plate or at any second point of the plate. The contour C is possibly a circle of radius R centered on a point P. This fourth embodiment comprises an emitter, and is therefore an active device.

In a fifth embodiment of the device, the device comprises two emitters E1, E2 and one receiver R1. FIGS. 7a, 7b and 7c show an example of a device according to this fifth embodiment. The receiver R1, the emitters E1, E2 can be adapted to measure or to generate a wave, on the contour C or at any first point of the plate or at any second point of the plate. The contour C is possibly a circle of radius R centered on a point P. This fifth embodiment comprises two emitters, and is therefore an active device.

Various embodiments of the method are possible, each adapted to one or more of the embodiments of the device. These embodiments of the method are described below.

In a first embodiment of the method, particularly suitable for the first and second embodiments of the device comprising a single receiver R1, said method for determining the physical parameter then comprises the following steps:
the receiver R1 is used to measure on the contour C a signal s₁(t) representative of the propagation of a wave in the plate.

The signal s₁(t) has zero amplitude for certain frequencies, particularly for antiresonances of the plate structure, but also for particular frequencies of the shape function.

In the case of a contour in the shape of a circle and of a substantially isotropic material and according to equations (6) and (8), the shape function is a Bessel function of the first kind J₀. This Bessel function is a function of a scale parameter a multiplied by the square root of the frequency f of the wave:

J₀(Z)=J₀(a\sqrt{f}), and

it is canceled out for the zeros Zₙ, Zₙ=a\sqrt{f}

In the other cases in which the material is not isotropic or the contour C is not a circle, a shape function can be determined numerically, also having zeros for certain specific frequencies.

A set of test frequencies fₙ is considered, n being a zero or positive integer index of between zero and N, N also being a positive integer, for example equal to five. The test frequencies fₙ are defined as proportional to the square of the zeros Zₙ of the Bessel function of the first kind J₀. If, for the test frequencies fₙ, the signal s₁(t) has a low or zero amplitude, and for example less than a predetermined threshold S, then these test frequencies f₁ correspond to the zeros of the Bessel function J₀ and the scale parameter a of the Bessel function can be calculated by:

$$a = \frac{{Z}_{n}}{\sqrt{{f}_{n}}}$$

for any n between zero and N.

A physical parameter can then be calculated.

According to equation (9), the product V_{P}h which multiplies the thickness h and the propagation speed V_{P} of a wave in the plate at point P, can be calculated by:

$${V}_{P} h = 4 \sqrt{3} π \frac{1}{{a}^{2}} {R}^{2} or {V}_{P} h = 4 \sqrt{3} π \frac{{f}_{n}}{{Z}_{n}^{2}} {R}^{2} \qquad ( 11 )$$

for n between 0 and N,

where

fₙ is the test frequency of index n of the set,

Zₙ is the zero of index n of the Bessel function of the first kind J₀, said zero Zₙ corresponding to said test frequency fₙ of the same index, and

R is the radius of the contour C.

If the value of the propagation speed V_{P} of a wave in the material of the plate is known, the thickness of the plate at point P can be calculated by:

$$h = 4 \sqrt{3} π \frac{1}{{a}^{2}} \frac{{R}^{2}}{{V}_{P}} or h = 4 \sqrt{3} π \frac{{f}_{n}}{{Z}_{n}^{2}} \frac{{R}^{2}}{{V}_{P}} \qquad ( 12 )$$

for n between 0 and N.

If the value of the plate thickness h is known, the propagation speed of a wave in the plate can be calculated by:

$${V}_{P} = 4 \sqrt{3} π \frac{1}{{α}^{2}} \frac{{R}^{2}}{h} \\ or \\ {V}_{P} = 4 \sqrt{3} π \frac{{f}_{n}}{{Z}_{n}^{2}} \frac{{R}^{2}}{h} \qquad ( 13 )$$

for n between 0 and N.

In a second embodiment of the method, particularly suitable for the third and fourth embodiments of the device of the invention comprising at least two receivers R1, R2 and possibly an emitter E1, one of them being on the contour C (FIGS. 5a, 6a and 6b), said method for determining the physical parameter then comprises the following steps:
the first receiver R1 is used to measure a first signal s₁(t),
the second receiver R2 is used to measure a second signal s₂(t),
the second signal is phase shifted by π/2.

As a result, if the first signal is of the type

s₁(t)=cos(2πft),

then according to equation 6, the second phase-shifted signal s*₂(t) can be written:

s*₂=AJ₀(kR)sin(2πft)

Meaning s(t) is the sum of s₁(t) and s*₂(t).

Postulating that tan(φ)=AJ₀(kR), we obtain:

$$s ( t ) = \frac{cos ( 2 π f t - ϕ )}{cos ( ϕ )}$$

As a result, for the zeros of the Bessel function of the first kind J₀, tan(φ)=0. Therefore φ=0. Under these conditions, the summed signal s(t) is in phase with the first signal s₁(t).

To determine whether one signal is in phase with another, any technique may be used in the time or frequency domain.

The second embodiment then also comprises a step in which test frequencies fₙ are defined as proportional to the square of the zeros Zₙ of the Bessel function of the first kind J₀. If, for the test frequencies fₙ, the signal s₁(t) is substantially in phase with a summed signal s(t) corresponding to the sum of the first signal and the second signal phase-shifted by π/2, then these test frequencies fₙ, correspond to the zeros of the Bessel function J₀.

A physical parameter of the plate can then be calculated, using the formulas 11 to 13 defined above.

This second embodiment of the method is also usable with the fifth embodiment of the device (FIGS. 7a, 7b and 7c) comprising two emitters E1, E2 and a single receiver R1.

In this case:
a first wave is generated in the plate by a first emission signal e₁(t) for the first emitter E1,
the first receiver R1 is used to measure a first signal s₁(t) representative of said first emitted wave,
a second wave is generated in the plate by a second emission signal e₂(t) for the second emitter E2,
the first receiver R1 is used to measure a second signal s₂(t) representative of said second emitted wave.

Then the second signal s₂(t) is phase shifted by π/2 to form a second phase-shifted signal s*₂(t). The rest of the method is then identical to what is described above.

The two described variants of the second embodiment of the method therefore use phase shifting of the second signal at reception.

In a third embodiment of the method, phase shifting is performed at emission. This third embodiment of the method is particularly suitable for the fifth embodiment of the device comprising two emitters E1, E2 and one receiver R1 (FIGS. 7a, 7b and 7c). The method for determining the physical parameter then comprises the following steps:
a first wave is generated in the plate by a first emission signal e₁(t) for the first emitter E1,
the first receiver R1 is used to measure a first signal s₁(t) representative of said first emitted wave,
a second wave is generated in the plate by a second emission signal e₂(t) for the second emitter E2,
the first receiver R1 is used to measure a second signal s₂(t) representative of said second emitted wave.

A summed signal s(t) is then calculated, which is the sum of the first signal s₁(t) and the second signal s₂(t).

s(t)=s₁(t)+s₂(t).

If the first signal s₁(t) is in phase with the summed signal s(t), for a set of test frequencies fₙ, the test frequencies fₙ being proportional to the square of the zeros Zₙ of the Bessel function of the first kind J₀, then these frequencies correspond to the specific frequencies desired.

A physical parameter of the plate can then be calculated, using the formulas 11 to 13 defined above.

As a variant, the emissions from the first and second emitters are simultaneous. In this case, the method for determining the physical parameter then comprises the following steps:
a first wave is generated in the plate by a first emission signal e₁(t) for the first emitter E1, and simultaneously a second wave is generated by a second emission signal e₂(t) for the second emitter E2, and
the first receiver R1 is used to measure a first signal s₁(t) representative of the superpositioning of said first and second emitted waves at the location of the first receiver R1.

The second emission signal e₂(t) is phase shifted by π/2 relative to the first emission signal e₁(t).

If the first signal s₁(t) is in phase with the first emission signal e₁(t), for a set of test frequencies fₙ, the test frequencies fₙ being proportional to the square of the zeros Zₙ of the Bessel function of the first kind J₀, then these frequencies correspond to the specific frequencies desired.

A physical parameter of the plate can then be calculated, using the formulas 11 to 13 defined above.

In a fourth embodiment of the method, particularly suitable for the third and fourth embodiments of the device of the invention comprising at least two receivers R1, R2 and possibly an emitter E1, one of them being on the contour C (FIGS. 5, 6a and 6b), said method for determining the physical parameter comprises the following steps:
the first receiver R1 is used to measure a first signal Oh and a first Fourier transform S₁(f) of this first signal is calculated,
the second receiver R2 is used to measure a second signal s₂(t), and a second Fourier transform S₂(f) of this second signal is calculated.

The first signal s₁(t) and the second signal s₂(t) are in phase or in phase opposition for specific frequencies corresponding to the abscissas for which the Bessel function J₀ presents a zero.

These frequencies can then be identified:
either directly by comparing the sign of the real parts of the Fourier transforms,
or indirectly by calculating a phase difference.

In the first case, the sign of the real part of the first Fourier transform S₁(f) is compared to the sign of the real part of the second Fourier transform S₂(f). One must observe the frequency bands in which the signs are identical and the frequency bands in which the signs are opposite. The transition frequencies between these frequency bands allow identifying the specific frequencies of the zeros of the Bessel function.

For example, a test function ƒₜₑₛₜ(f) is calculated which has a first value V₁ if the signs are the same and a second value V₂ if the signs are different:

$$\{ \begin{matrix}if sign ( ℜ ( {S}_{1} ( f ) ) ) = sign ( ℜ ( {S}_{2} ( f ) ) ) & then {f}_{test} ( f ) = {V}_{1} \\ else & {f}_{test} ( f ) = {V}_{2}\end{matrix}$$

where V1 and V2 can have any differing values. For example, V₁=1 and V₂=0.

Specific frequencies fₙ at which the test function ƒₜₑₛₜ(f) changes value are looked for, either from the first value V₁ to the second value V₂, or conversely from the second value V₂ to the first value V₁.

A physical parameter of the plate can then be calculated, using the formulas 11 to 13 described above.

In the second case, a phase difference Δφ between the first Fourier transform S₁(f) and the second Fourier transform S₂(f) is calculated, by:

Δφ=φ(S₂(f)−S₁(f));

The phase difference Δφ then presents phase jumps between 0 and π or between π and 0, for the specific frequencies desired.

Specific frequencies fₙ of the phase difference Δφ are looked for, at which said phase difference Δφ has such a jump, said specific frequencies fₙ being proportional to the square of the zeros Zₙ, of the function of the first kind J₀.

Any technique may be employed for detecting a jump in a function, such as the phase difference. In particular, one can detect an increase or decrease that crosses an intermediate threshold, near π/2, with or without hysteresis.

Once the frequencies are identified, it is then possible to calculate a physical parameter of the plate, using the formulas 11 to 13 described above.

This fourth embodiment of the method is also usable with the fifth embodiment of the device (FIGS. 7a, 7b and 7c) comprising two emitters E1, E2 and a single receiver R1.

In this case:
a first wave is generated in the plate by a first emission signal e₁(t) for the first emitter E1,
the first receiver R1 is used to measure a first signal s₁(t) representative of said first emitted wave,
a second wave is generated in the plate by a second emission signal e₂(t) for the second emitter E2,
the first receiver R1 is used to measure a second signal s₂(t) representative of said second emitted wave.

A first Fourier transform S₁(f) of the first signal s₁(t) and a second Fourier transform S₂(f) of the second signal s₂(t) are calculated.

Similarly to the third embodiment of the method, the first signal s₁(t) and the second signal s₂(t) are in phase or in phase opposition for specific frequencies corresponding to the abscissas for which the Bessel function J₀ presents a zero.

In the rest of the method, the specific frequencies are identified in the same manner, either directly by comparing the sign of the real part of the first Fourier transform to the sign of the real part of the second Fourier transform, or indirectly by calculating a phase difference dip, with the rest of the method being identical.

Having determined the specific frequencies, a physical parameter of the plate can be calculated using the formulas 11 to 13 described above.

In a fifth embodiment of the method, particularly suitable for the third and fourth embodiments of the device of the invention comprising at least two receivers R1, R2 and possibly an emitter E1, one of them being on the contour C (FIGS. 5, 6a and 6b), said method then comprises the following steps:
the receiver R1 is used to measure a first signal s₁(t), and a first Fourier transform S₁(f) of this first signal is calculated,

the receiver R2 is used to measure a second signal s₁(t), and a second Fourier transform S₂(f) of this second signal is calculated.

When the contour C is a circle and the material of the plate is a substantially isotropic material, equation 6 can be applied to identify, for a set of test frequencies fₙ, the form of the Bessel function of the first kind J₀.

This identification can be done:
either by the moduli,
or by the phases.

In the first case, one looks for the parameters a and b of a parametric function |bJ₀(a\sqrt{f})| which draw nearest to |S₂(f)/S₁(f)| for a set of test frequencies fₙ, |.| being the modulus function.

In the second case, one looks for the parameters a and b of a parametric function φ(bJ₀(a\sqrt{f})) which draw nearest to φ(S₂(f)/S₁(f)) for a set of test frequencies fₙ, φ(.) being the phase function.

Once this identification of the scale parameter a has been made, the link between the abscissa a\sqrt{f} of the Bessel function J₀ and the physical parameter of the plate is established by equation 8.

A physical parameter of the plate can be calculated, using the formulas 11 to 13 described above.

This fifth embodiment of the method is also usable with the fifth embodiment of the device (FIGS. 7a, 7b and 7c) comprising two emitters E1, E2 and a single receiver R1.

In this case:
a first wave is generated in the plate by a first emission signal e₁(t) for the first emitter E1,
the first receiver R1 is used to measure a first signal s₁(t) representative of said first emitted wave,
a second wave is generated in the plate by a second emission signal e₂(t) for the second emitter E2,
the first receiver R1 is used to measure a second signal s₂(t) representative of said second emitted wave.

A first Fourier transform S₁(f) of the first signal s₁(t) and a second Fourier transform S₂(f) of the second signal s₂(t) are calculated.

Then, when the contour C is a circle and when the material of the plate is a substantially isotropic material, one can also apply equation 6 to identify, for a set of test frequencies fₙ, the form of the Bessel function of the first kind J₀.

This identification is done either on the moduli, or on the phases, as above, to obtain a scale parameter a.

A physical parameter of the plate can be calculated, using the formulas 11 to 13 described above.

In this manner, one or more embodiments of the method can be applied to each embodiment of the device, and a physical parameter of the plate can be determined in all embodiments of the method.

The above methods can also be applied if the material of the plate is anisotropic. In this case, the contour C will have a shape that is not a circle.

In a first case, the propagation speed of a wave is dependent on the direction according to a law of ellipses of the type:

Vₚ²[cos²θ/Vₚₓ²+sin²θ/V_{py}²]=1

where
X is an axis in the direction of the major axis of the ellipse,
Y is an axis in the direction of the minor axis of the ellipse,
X and Y being orthogonal axes,
θ is the angle of the direction of the propagation of the wave relative to the X axis,
Vₚₓ is the propagation speed of the wave along the X axis,
V_{py} is the propagation speed along the Y axis.

Equation (6) can then be written for a contour that has the shape of an ellipse:

Wₑₗₗᵢₚₛₑ(\vec{r})=2πAJ₀(kR)Gₚₗₐₜₑ(|\vec{r}−\vec{r}ₛ|)

If two receivers (R1, R2) are used at points of the plate at coordinates \vec{r} and \vec{r}₂ which are not part of the ellipse-shaped contour, the above relation can be written twice, to determine:

W′ₑₗₗᵢₚₛₑ(\vec{r}₁)W′ₑₗₗᵢₚₛₑ(\vec{r}₂)*=|2πAJ₀(kR)|²Gₚₗₐₜₑ(|\vec{r}₁−\vec{r}ₛ|)Gₚₗₐₜₑ(|\vec{r}₂−\vec{r}ₛ|)*

where
indicates the conjugate function.

As a result, the phase of W′ₑₗₗᵢₚₛₑ(\vec{r}₁)W′ₑₗₗᵢₚₛₑ(\vec{r}₂)* must be equal to the phase of Gₚₗₐₜₑ(|\vec{r}₁−\vec{r}ₛ|)Gₚₗₐₜₑ(|\vec{r}₂−\vec{r}ₛ|)*.

A test method is deduced from this in which one or more emitters (E2) are used, adapted to generate a wave on a test contour Cₙ having a predetermined ellipse shape, where n is the positive integer index. A test method is applied to each of them to determine the best test contour Cₙ, meaning the shape of the ellipse, comprising the following steps:
a first wave is generated in the plate by a first emission signal e₁(t) for the first emitter (E1),
the first receiver (R1) is used to measure a first signal s(t) representative of said first emitted wave, and a first Fourier transform S₁₁(f) of this first signal is calculated,
the second receiver is used to measure a second signal s₁₂(t) representative of said first emitted wave, and a second Fourier Transform S₁₂(f) of this second signal is calculated,
a second wave is generated in the plate by a second emission signal e₂(t) for the second emitter (E2),
the first receiver (R1) is used to measure a third signal s₂₁(t) representative of said second emitted wave, and a third Fourier transform S₂₁(f) of this third signal is calculated,
the second receiver is used to measure a fourth signal s₂₂(t) representative of said second emitted wave, and a fourth Fourier transform S₂₂(f) of this fourth signal is calculated,
the following phase difference function is calculated:

Δφ(f)=φ(S₁₁(f)·S₁₂(f)*)−φ(S₂₁(f)·S₂₂(f)*)

where
* indicates the conjugate function, and
φ(.) is the phase function.

The ellipse shape of the test contour Cₙ then corresponds to an optimum contour, such that the first wave is propagated and spatially superimposed on the plate substantially on the second wave, when the phase difference function Δφ(f) is minimal for a set of test contours Cₙ to which the above test steps are applied.

With this test method, the optimum shape is determined for the contour C to be used in the method of the invention for which all the equations established for a circle are now usable for the ellipse.

In a more general case, in which the propagation speed of a wave is dependent on the direction according to a law for a predetermined shape, the contour C to be used in all embodiments of the method of the invention will have this same predetermined shape, in order to be able to apply the case of the circular contour C as was done above for the ellipse. In particular, equation 6 will be satisfied and the shape function used will be a Bessel function of the first kind J₀.

In other words, the ideal shape of the contour C can be determined by the angular variation of the phase velocity of the first bending mode of the plate. For an isotropic plate, the contour C is circular. For an orthotropic plate, the contour C is elliptical. For any plate, an analysis of the first bending mode may enable predetermining the ideal shape to be used for the contour C.

The contour C may also be of a shape not corresponding to the profile of the speeds in the plate material.

For example, the contour C may be a rectangle as shown in FIG. 10, centered on point P, P being the location where the physical parameter is estimated. The rectangle contour C comprises a predetermined number of contour points Cj, j being a positive integer index of between 1 and U. U is for example equal to eight, such that the eight contour points Cj are positioned in the four corners and at the middle of each side of the rectangle.

The method comprises the following steps:
at each point of the contour Cj a contour signal sⱼ(t) is measured that is representative of the wave at each of these contour points;
any interpolation technique is used to calculate signals sₖ(t) representative of the wave at virtual points CIₖ positioned along a virtual contour CI inside the rectangle contour C. In particular, the virtual contour CI may have the predetermined shape of a circle of radius R, R being for example less than half of the smallest side of the rectangle;
the sum of the signals sₖ(t) representative of the wave at the virtual points CIₖ is calculated, to estimate a first signal s₁(t) along the virtual contour CI, and a first Fourier transform S₁(f) of said first signal is calculated.

One can then apply one of the previously described methods to the virtual contour CI of radius R. In particular:
at point P a second signal s₂(t) representative of the wave at point P is measured, and a second Fourier transform S₂(f) of said second signal is calculated;
a scale parameter a is determined such that the modulus of the following Bessel function of the first kind J₀:

|bJ₀(a\sqrt{f})|,

where b is another scale parameter, and

|.| is the modulus function,

best approaches:

|S₂(f)/S₁(f)|

for a set of test frequencies fₙ.

A physical parameter is then determined as has already been described.

As shown in FIG. 11, the contour C may be square in shape.

In a first variant applied to a contour C that is square in shape, the contour points Cj are considered to be close to a circle CI of radius R calculated by:

$$R = \frac{{d}_{1} + {d}_{2}}{2}$$

where
d₁ is half the length of the longest median of the square contour, and
d₂ is the length of the diagonal of the square contour.

One can then apply one of the methods described above to the circle CI with the above calculated radius.

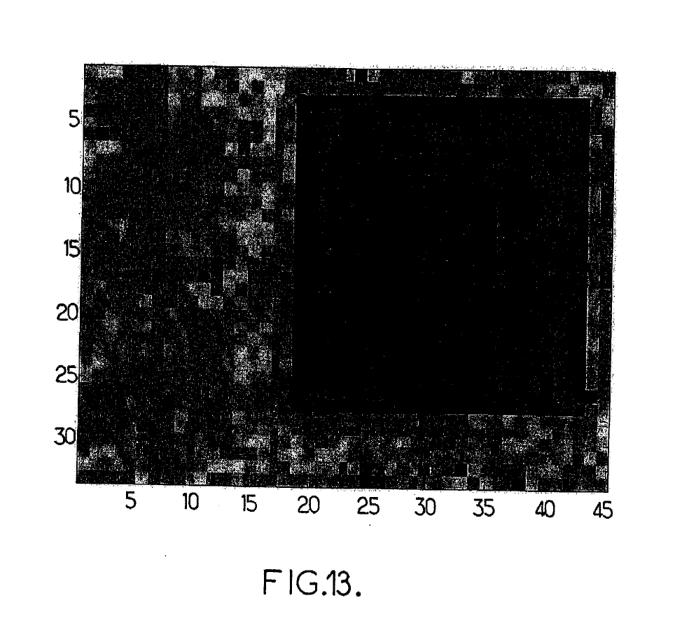

In a second variant represented in FIG. 12 and applied to a contour C that is square in shape, the contour points Cj are included in two circles:
a first circle CI1 of radius d₁, passing through the contour points Cj located in the middle of the sides of the square, and
a second circle CI2 of radius d₂, passing through the contour points Cj located at the corners of the square.

Equation (6) is now written as two equations:

W_{circle1}(r)=2πAJ₀(kd₁)Gₚₗₐₜₑ(r),

and

W_{circle2}(r)=2πAJ₀(kd₂)Gₚₗₐₜₑ(r).

Using one of the methods described above, one then compares:

W_{circle1}J₀(kd₂)+W_{circle2}J₀(kd₁),

and

J₀(kd₂)J₀(kd₁)Gₚₗₐₜₑ(r)

to determine a physical parameter of the plate at point P.

In addition, the method using contour points positioned on a rectangular contour C may advantageously be implemented with a scanning vibrometer. The scanning vibrometer will provide vibration measurements for the wave propagating on the plate 1 for a set of points, distributed over a matrix grid on the plate 1.

Thus an image of the plate representing the physical parameter can be calculated, successively using each point of the grid as a reference point P where the physical parameter is to be determined, and the other points immediately surrounding this last point as points belonging to a closed contour C.

The image comprises a plurality of pixels. Each pixel:
corresponds to a point of the plate, for example a point measured by a scanning vibrometer, and
represents a physical parameter of the plate at said point of the plate, determined by one of the methods described above.

In particular, it is possible, for example, to provide an image of the thickness of a plate, remotely and without direct contact, said image having a spatial precision equal to the distance between the measured points. Such an image therefore allows detecting, determining, and localizing a difference in thickness in the plate.

FIG. 13 represents an example of such an image for an aluminum plate 4 mm thick having an area 100×100 mm that is machined to a thickness of 3.5 mm. The distance between each pixel of the image is 4 mm.

Such products and methods may be implemented for measuring the thicknesses of plates or sheets on large structures (boat hull, aircraft fuselage, storage tank, buildings) or small structures.

They can be used with flat, curved, or tubular plates.

In the case of curved plates or tubes, the waves propagate at speeds varying with the direction of propagation. The device will then advantageously have a closed contour C of an elliptical shape adapted to the curve of the structure, as in the case of a flat plane consisting of an anisotropic material.

Such products and products have numerous industrial applications:
monitoring the thickness of structures such as plates, sheets, and tubes;
monitoring the thickness of a deposit on these structures, such as scale deposits in water pipelines;
monitoring the appearance of defects in these structures, from damage or aging in these structures.

1. A method for determining a physical parameter representative of a point P of a plate, wherein the physical parameter is chosen from among a thickness of the plate h, a propagation speed of a wave in the plate V_{P}, and a product V_{P}h of the thickness and the propagation speed of a wave in the plate, and said method is implemented by a device comprising:
at least a first receiver adapted to measure a wave propagating in the plate, and
a calculation unit connected to said first receiver,
said method being characterized by said method comprising the following steps:
said first receiver is used to measure a first signal s₁(t) representative of a wave propagating in the plate,
a closed contour C surrounding said point P is defined on the plate, the contour C being the plate location at which either a first emitter is used to generate a wave propagating in the plate, or said first receiver is used to measure said first signal s₁(t) representative of a wave propagating in the plate, and
the physical parameter is determined at point P of the plate by using at least said first signal s₁(t) to identify a shape function ƒₛₕₐₚₑ(f) in the following relation:
W_{contour}(\vec{r})=fₛₕₐₚₑ(f)Gₚₗₐₜₑ(\vec{r}−\vec{r}ₛ)
where
W_{contour} is a Green's function representing the wave along the contour C,
Gₚₗₐₜₑ is a Green's function representing the wave at a point of vector position \vec{r} of the plate that is not a part of the contour C, relative to a point S of position vector \vec{r}ₛ of the plate representing a source of the wave, and
said shape function ƒₛₕₐₚₑ(f) is dependent on at least the frequency f of the wave and the physical parameter, and is adapted to the shape of the contour C.

2. The method according to claim 1, wherein the shape function is a Bessel function of the first kind J₀(Z) comprising zeros Zₙ, n being a positive integer or zero, said Bessel function being a function of a scale parameter a multiplied by the square root of the frequency f of the wave, such that:
J₀=J₀(a\sqrt{f}).

3. The method according to claim 2, wherein the first receiver is adapted to measure a wave on the contour C, and said method comprises the following step:
if the first signal s₁(t) has an amplitude less than a predetermined threshold for a set of test frequencies fₙ, the test frequencies fₙ being proportional to the square of the zeros Zₙ of the Bessel function of the first kind J₀, then the scale parameter a is calculated by:
$$a = \frac{{Z}_{n}}{\sqrt{{f}_{n}}} .$$

4. The method according to claim 2, wherein the device additionally comprises a first emitter, one of the first emitter and first receiver being adapted either to generate or to measure a wave on the contour C, the other being adapted either to generate or to measure a wave at a point of the plate that is not a part of the contour C, and said method comprises the following steps:
a first wave is generated in the plate by a first emission signal e₁(t) for the first emitter,
the first receiver is used to measure a first signal s₁(t) representative of said first emitted wave, and
if the first signal s₁(t) has an amplitude less than a predetermined threshold for a set of test frequencies fₙ, the test frequencies fₙ being proportional to the square of the zeros Zₙ of the Bessel function of the first kind J₀, then the scale parameter a is calculated by:
$$a = \frac{{Z}_{n}}{\sqrt{{f}_{n}}} .$$

5. The method according to claim 2, wherein the device additionally comprises a second receiver, the first receiver being adapted to measure a wave on the contour C and the second receiver being adapted to measure a wave at a point of the plate that is not a part of the contour C, and said method comprises the following steps:
the first receiver is used to measure a first signal s₁(t) representative of a first wave, and simultaneously the second receiver is used to measure a second signal s₂(t) representative of said same first wave.

6. The method according to claim 2, wherein the device additionally comprises:
a second receiver, and
a first emitter,
one of the first receiver, second receiver, and first emitter being adapted to measure or to generate a wave on the contour C, and said method comprises the following steps:
a first wave is generated in the plate by a first emission signal e₁(t) for the first emitter,
the first receiver is used to measure a first signal s₁(t) representative of said first emitted wave, and simultaneously the second receiver is used to measure a second signal s₂(t) representative of said same first emitted wave.

7. The method according to claim 2, wherein the device additionally comprises:
a first emitter, and
a second emitter,
one of the first receiver, first emitter, and second emitter being adapted to measure or to generate a wave on the contour C, and said method comprises the following steps:
a first wave is generated in the plate by a first emission signal e₁(t) for the first emitter (E1),
the first receiver is used to measure a first signal s₁(t) representative of said first emitted wave,
a second wave is generated in the plate by a second emission signal e₂(t) for the second emitter,
the first receiver is used to measure a second signal s₂(t) representative of said second emitted wave.

8. The method according to claim 7, wherein the second emission signal e₂(t) is phase shifted by π/2 relative to the first emission signal e₁(t), and said method comprises the following steps:
a summed signal s(t) is calculated which is the sum of the first signal s₁(t) and a second signal s₂(t), and
if the first signal s₁(t) is in phase with the summed signal s(t) for a set of test frequencies fₙ the test frequencies being proportional to the square of the zeros Zₙ of the Bessel function of the first kind J₀, then the scale parameter a is calculated by:
$$a = \frac{{Z}_{n}}{\sqrt{{f}_{n}}} .$$

9. The method according to claim 2, wherein the device additionally comprises:
a first emitter, and
a second emitter,
one of the first receiver, first emitter, and second emitter being adapted to measure or to generate a wave on the contour C, and said method comprises the following steps:
a first wave is generated in the plate by a first emission signal e₁(t) for the first emitter, and simultaneously a second wave is generated by a second emission signal e₂(t) for the second emitter, and
the first receiver is used to measure a first signal s₁(t) representative of the superpositioning of said first and second emitted waves at the location of the first receiver.

10. The method according to claim 9, wherein the second emission signal e₂(t) is phase shifted by π/2 relative to the first emission signal e₁(t), and said method comprises the following steps:
if the first signal s₁(t) is in phase with the first emission signal e₁(t) for a set of test frequencies fₙ, the test frequencies fₙ being proportional to the square of the zeros Zₙ of the Bessel function of the first kind J₀, then the scale parameter a is calculated by:
$$a = \frac{{Z}_{n}}{\sqrt{{f}_{n}}} .$$

11. The method according to claim 5, comprising the following steps:
a summed signal s(t) is calculated, which is the sum of the first signal s₁(t) and a phase-shifted second signal s₂*(t), the phase-shifted second signal s₂*(t) being equal to the second signal s₂(t) phase shifted by π/2, and
if the first signal s₁(t) is in phase with the summed signal s(t), for a set of test frequencies fₙ, the test frequencies fₙ being proportional to the square of the zeros Zₙ of the Bessel function of the first kind J₀, then the scale parameter a is calculated by:
$$a = \frac{{Z}_{n}}{\sqrt{{f}_{n}}} .$$

12. The method according to claim 5, comprising the following steps:
a first Fourier transform S₁(f) of the first signal s₁(t) and a second Fourier transform S₂(f) of the second signal s₂(t) are calculated,
a test function ƒₜₑₛₜ(f) is calculated which compares the sign of the real part of the first Fourier transform S₁(f) to the sign of the real part of the second Fourier transform S₂(f), and which assigns a first value V₁ if the signs are identical and a second value V₂ if the signs are different:
$$\{ \begin{matrix}if sign ( ℜ ( {S}_{1} ( f ) ) ) = sign ( ℜ ( {S}_{2} ( f ) ) ) & then {f}_{test} ( f ) = {V}_{1} \\ else & {f}_{test} ( f ) = {V}_{2}\end{matrix}$$
specific frequencies fₙ at which the test function ƒₜₑₛₜ(f) changes value are looked for, either changing from the first value V₁ to the second value V₂, or conversely from the second value V₂ to the first value V₁, and
the scale parameter a is calculated by:
$$a = \frac{{Z}_{n}}{\sqrt{{f}_{n}}} .$$

13. The method according to claim 5, comprising the following steps:
a first Fourier transform S₁(f) of the first signal s₁(t) and a second Fourier transform S₂(f) of the second signal s₂(t) are calculated,
a phase difference Δφ between the first Fourier transform and the second Fourier transform is calculated, using:
Δφ=φ(S₂(f)−S₁(f))
specific frequencies fₙ of the phase difference Δφ are looked for, at which said phase difference has a jump between 0 and π or between π and 0, and which are proportional to the square of the zeros Zₙ of the Bessel function of the first kind J₀, and
the scale parameter a is calculated by:
$$a = \frac{{Z}_{n}}{\sqrt{{f}_{n}}} .$$

14. The method according to claim 5, comprising the following steps:
a first Fourier transform S₁(f) of the first signal s₁(t) and a second Fourier transform S₂(f) of the second signal s₂(t) are calculated,
the scale parameter a is determined such that the modulus of the following shape function:

|bJ₀(a\sqrt{f})|,
where b is another scale parameter, and

|.| is the modulus function,
best approaches:

|S₂(f)/S₁(f)|

for a set of test frequencies fₙ.

15. The method according to claim 5, comprising the following steps:
a first Fourier transform S₁(f) of the first signal s₁(t) and a second Fourier transform S₂(f) of the second signal s₂(t) are calculated,
the scale parameter a is determined such that the phase of the following shape function:
φ(bJ₀(a\sqrt{f})),
where b is another scale parameter, and
φ(.) is the phase function,
best approaches:
φ(S₂(f)/S₁(f))
for a set of test frequencies fₙ.

16. The method according to claim 2, wherein the physical parameter that is the product V_{P}h, said product being the thickness multiplied by the propagation speed of a wave in the plate, is determined by the following formula:
$${V}_{P} h = 4 \sqrt{3} π \frac{1}{{a}^{2}} {R}^{2}$$
where
a is the scale parameter of the Bessel function, previously determined, and
R is the length of a segment between the point P and a point of the contour C in the direction of the wave.

17. The method according to claim 2, wherein the physical parameter that is the thickness h of the plate is determined by the following formula:
$$h = 4 \sqrt{3} π \frac{1}{{a}^{2}} \frac{{R}^{2}}{{V}_{P}}$$
where
a is the scale parameter of the Bessel function, previously determined,
R is the length of a segment between the point P and a point of the contour C in the direction of the wave, and
V_{P} is the known propagation speed of a wave in the material of the plate.

18. The method according to claim 2, wherein the physical parameter that is the propagation speed V_{P} of a wave in the plate is determined by the following formula:
$${V}_{P} = 4 \sqrt{3} π \frac{1}{{a}^{2}} \frac{{R}^{2}}{h}$$
where
a is the scale parameter of the Bessel function, previously determined,
R is the length of a segment between the point P and a point of the contour C in the direction of the wave, and
h is the known thickness of the plate.

19. The method according to claim 1, wherein the contour C is substantially a circle of radius R centered on the point P.

20. The method according to claim 1, wherein the contour C is substantially an ellipse centered on the point P.

21. The method according to claim 20, wherein the shape of the contour C is determined beforehand using:
a test device comprising:
a first emitter adapted to generate a wave at point P,
at least a second emitter adapted to generate a wave on a test contour Cₙ having the predetermined shape of an ellipse, n being a positive integer index,
first and second receivers adapted to measure a wave at points that are not a part of the test contour Cₙ, and using:
a test method comprising the following test steps:
a first wave is generated in the plate by a first emission signal e₁(t) for the first emitter,
the first receiver is used to measure a first signal sat) representative of said first emitted wave, and a first Fourier transform S₁₁(f) of this first signal is calculated,
the second receiver is used to measure a second signal s₁₂(t) representative of said first emitted wave, and a second Fourier transform S₁₂(f) of this second signal is calculated,
a second wave is generated in the plate by a second emission signal e₂(t) for the second emitter,
the first receiver is used to measure a third signal s₂₁(t) representative of said second emitted wave, and a third Fourier transform S₂₁(f) of this third signal is calculated,
the second receiver is used to measure a fourth signal s₂₂(t) representative of said second emitted wave, and a fourth Fourier transform S₂₂(f) of this fourth signal is calculated,
the following phase difference function is calculated:
Δφ(f)=φ(S₁₁(f)·S₁₂(f)*)−φ(S₂₁(f)·S₂₂(f)*)
where
indicates the conjugate function, and
φ(.) is the phase function, and
the ellipse shape of the test contour Cₙ corresponds to an optimum contour, such that the first wave is propagated and spatially superimposed on the plate substantially on the second wave, when the phase difference function Δφ(f) is minimal for a set of test contours Cₙ to which the above test steps are applied.

22. The method according to claim 1, wherein the contour C is substantially a rectangle centered on the point P.

23. The method according to claim 22, wherein the contour C comprises eight contour points C1 to C8, and wherein said contour points and the point P form a regular rectangular grid.

24. (canceled)

25. An imaging method, wherein an image of a plate is constructed, said image comprising a plurality of pixels, each pixel corresponding to a point of the plate and representing a physical parameter of the plate at said point of the plate, said physical parameter of said point being determined by the method according to claim 1.

26. A device for implementing the method for determining a physical parameter representative of a point P of a plate, wherein the physical parameter is chosen from among a thickness of the plate h, a propagation speed of a wave in the plate V_{P}, and a product V_{P}h of a thickness and a propagation speed of a wave in the plate,
said device comprising:
at least a first receiver adapted to measure a first signal s₁(1) representative of a wave propagating in the plate,
a closed contour C defined by surrounding said point P, the contour C being the plate location at which either a first emitter is used to generate a wave propagating in the plate, or said first receiver is used to measure said first signal s₁(t) representative of a wave propagating in the plate, and
a calculation unit connected to said first receiver,
said calculation unit being adapted to determine the physical parameter at point P of the plate by using at least said first signal s₁(t) to identify a shape function ƒₛₕₐₚₑ(f) in the following relation:
W_{contour}(\vec{r})=fₛₕₐₚₑ(f)Gₚₗₐₜₑ(\vec{r}−\vec{r}_{S})
where
W_{contour} is a Green's function representing the wave along the contour C,
Gₚₗₐₜₑ is a Green's function representing the wave at a point of position vector \vec{r} of the plate that is not a part of the contour C, relative to a point S of position vector \vec{r}ₛ of the plate representing a source of the wave, and
said shape function ƒₛₕₐₚₑ(f) is dependent on at least the frequency f of the wave and the physical parameter, and is adapted to the shape of the contour C.

27. The device according to claim 26, wherein the first receiver is a scanning laser vibrometer.

28. The device according to claim 27, additionally comprising a second receiver, and wherein the second receiver is realized by said scanning laser vibrometer.
